(19) United States
(12) Patent Application Publication
(10) Pub. No.: US 2010/0115239 A1
(43) Pub. Date: May 6, 2010

(54) VARIABLE INSTRUCTION WIDTH DIGITAL SIGNAL PROCESSOR

(75) Inventor: Andreas OLOFSSON, Lexington, MA (US)

Correspondence Address: WILMERHALE/BOSTON, 60 STATE STREET, BOSTON, MA, 02109, US

(73) Assignee: Adapteva Incorporated, Bedford, MA (US)

(21) Appl. No.: 12/608,339

(22) Filed: Oct. 29, 2009

Related U.S. Application Data
(60) Provisional application No. 61/197,511, filed on Oct. 29, 2008.

(51) Int. Cl. G06F 9/30; G06F 9/312

(52) U.S. Cl. 712/205; 712/208; 712/E09.028; 712/E09.033

(57) ABSTRACT

A DSP architecture achieves high code density and performance by using 16 bit encoding/decoding of three-register instructions and including orthogonal 64 register selection fields within a 32-bit instruction. A 64 entry register file allows high performance, while the 16-bit instruction size provides excellent code density in control type applications.

### CROSS-REFERENCE TO RELATED APPLICATION

This application claims priority under 35 U.S.C. Section 119(e) to Provisional Application Ser. No. 61/197,511, filed Oct. 29, 2008, which is incorporated herein by reference.

### FIELD OF THE INVENTION

The invention relates to methods for encoding a set of operations through a set of variable length instructions and apparatus for decoding the instructions.

### BACKGROUND

In embedded systems, three key processor performance metrics are performance, power efficiency, and code density. Processor code density is important because it directly effects how much memory is needed for a certain application. The more memory that is needed, the bigger, more expensive, and more port hungry the system becomes. If the instructions executed by a processor can be made smaller, less memory is needed to execute a certain program. If a complete program can fit within the processor's on-chip memory, power goes down significantly and the performance of the program is increased.

Most of today's successful embedded processors use some kind of variable width decoding to improve code density. ARM uses a short instruction mode called THUMB which is asserted by executing a special instruction. The Blackfin digital signal processor (DSP) has variable width instruction sizes, with the most common instructions encoded as 16-bit instructions. Complex Instruction Set Computers (CISC) architectures generally allow reading data directly from memory using special address modes and have many more instruction widths and generally have better code density than Reduced Instruction Set (RISC) based processors. However, the more complex decoding of the CISC computers generally leads to slower and more power hungry circuitry.

### SUMMARY

The DSP architecture described herein can achieve significantly better code density and performance in signal processing compared to current RISC-based DSPs, while achieving very high speed of operation of the decoding. The DSP architectures provides 16-bit encoding/decoding of three-register instructions, and orthogonal 64 register selection fields within a 32-bit instruction. The 64-entry register file can allow significantly higher performance compared to typical DSP architectures in demanding signal processing applications, while the 16-bit instruction size provides excellent code density in control type applications.

Other features and advantages will become apparent from the following detailed description, drawings, and claims.

### BRIEF DESCRIPTION OF THE DRAWINGS

FIG. 1 is a block diagram of a DSP architecture.

FIG. 2 is a table of instructions.

FIG. 3 is a block diagram of program memory and a buffer and decoder.

FIG. 4 is a block diagram of instruction decoder functionality.

FIG. 5 is an example of code.

### DETAILED DESCRIPTION

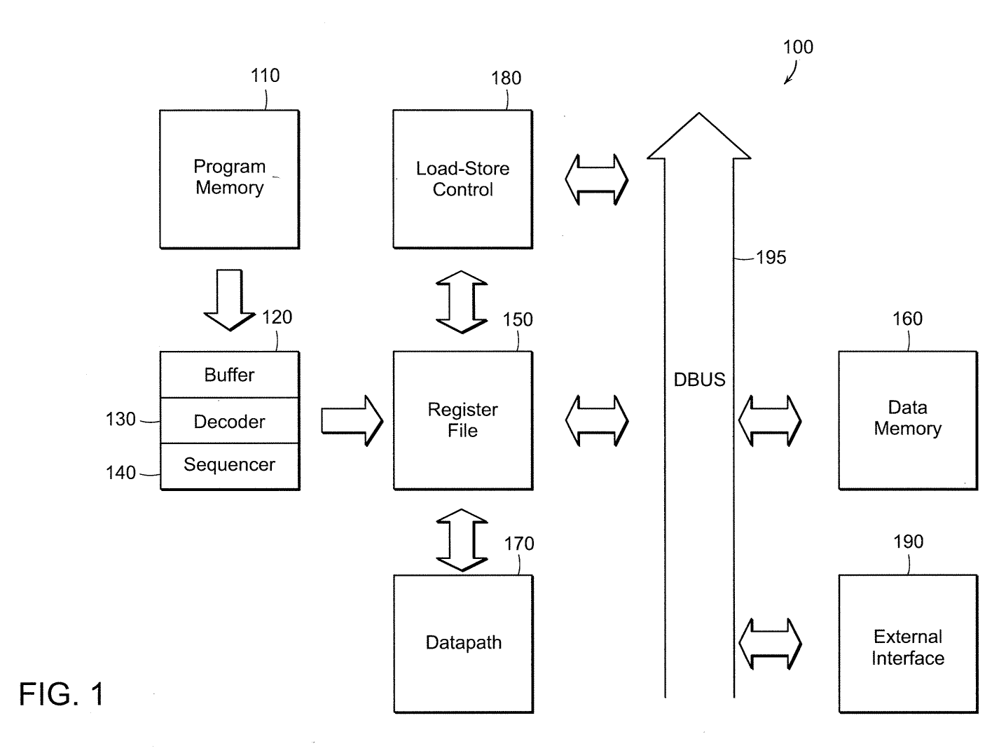

A digital signal processor (DSP) architecture containing a variable width decoder is shown in FIG. 1. The DSP 100 has the following components:

A program memory 110 is used to store a program being executed. The program memory can be separate from the data memory to improve performance, although it could be combined. The width of the program memory is at least 32 bits, but can be 64 bits or 128 bits.

An instruction alignment buffer 120 aligns instructions so that instructions in memory do not have to be aligned on program memory line boundaries. This feature increases code density and reduces power consumption.

An instruction decoder 130 decodes the instruction received from the instruction buffer 120 and sends control signals to a register file, execution units (not shown), and a program sequencer. The instruction decoder decodes the length of an instruction as 16 bits wide or 32 bits wide based on the type of instruction.

A program sequencer 140 controls the fetching of instructions from program memory 110. Sequencer 140 provides a fetch address to program memory 110 and a read signal when an instruction is read. The fetch is done whenever the instruction buffer is not full. The unit also controls non-linear program flows such as jumps, calls, and branches. Up to two instructions can be executed in parallel.

A register file 150 is a unified register file with up to 64 general purpose registers capable of being used for all 32-bit instructions. A large and unified register file is a useful feature of load-store RISC architectures, because there are no addressing modes that allow data variables to be loaded from the data memory with a compute instruction.

A data memory 160 is a multi-bank memory architecture that allows for the fetching of data for computation in parallel with fetching an instruction from program memory. This is generally referred to as a Harvard architecture. In signal processing applications, allowing for simultaneous instruction fetch and data loads often doubles application performance.

A datapath 170 that can include processing units for data processing functions. The processor instruction set is flexible and expandable, but has a core instruction set that all flavors of the processor implementations have. The base integer instructions can include only the following instructions: addition, subtraction, xor, or, and, logical left shift, logical right shift, and arithmetic left shift. More instructions can be added based on specific application needs, and may include floating point arithmetic, multiplication, and/or multiply accumulate operations. Datapath-based instructions can be executed in parallel with load-store instructions.

A load store control 180 enables parallel execution of datapath instructions and load/store of data.

The architecture also provides an external interface 190 and bus 195. The bus communicates with load store control 180, register file 150, data memory 160, and external interface 190.

Register file 150 is a single unified register file that is used for all computer operations, including pointer manipulation, floating point execution, and integer arithmetic. Most architectures today utilize a split register file architecture. One reason for the register file split in these architectures is that a large instruction set does not allow encoding of such a large set of registers in a 32-bit instruction. The trade-off made was for more complicated instruction sets rather than a large register file. In the processor described here, the register file is unified and even allow 64 entry register files with a 32-bit instruction set. The 64 entry three-operand instructions are set in a 32-bit instruction by reducing the number of unique instructions and by reducing the size of immediate constants.

In some other designs, there can be a separate 32 entry register file for floating point operations, meaning that there are 32 registers available for integer operations and 32 registers for floating point operations. In still other architectures, there are only 8 data registers and 8 pointer registers. In both cases, register spillage may occur when either the integer register usage or computational register usage exceeds the size of the respective register file sizes. By making the register file large, unified, and orthogonal, there is only one register constraint to optimize for when writing the code rather than two. The constraint is that the total number of registers must be less than 64. A large register file is useful in signal processing applications, since one data fetch bus has been removed and thus there is a desire have to reuse more of the data, leading to a large number of temporary variables held in the register file rather than memory.

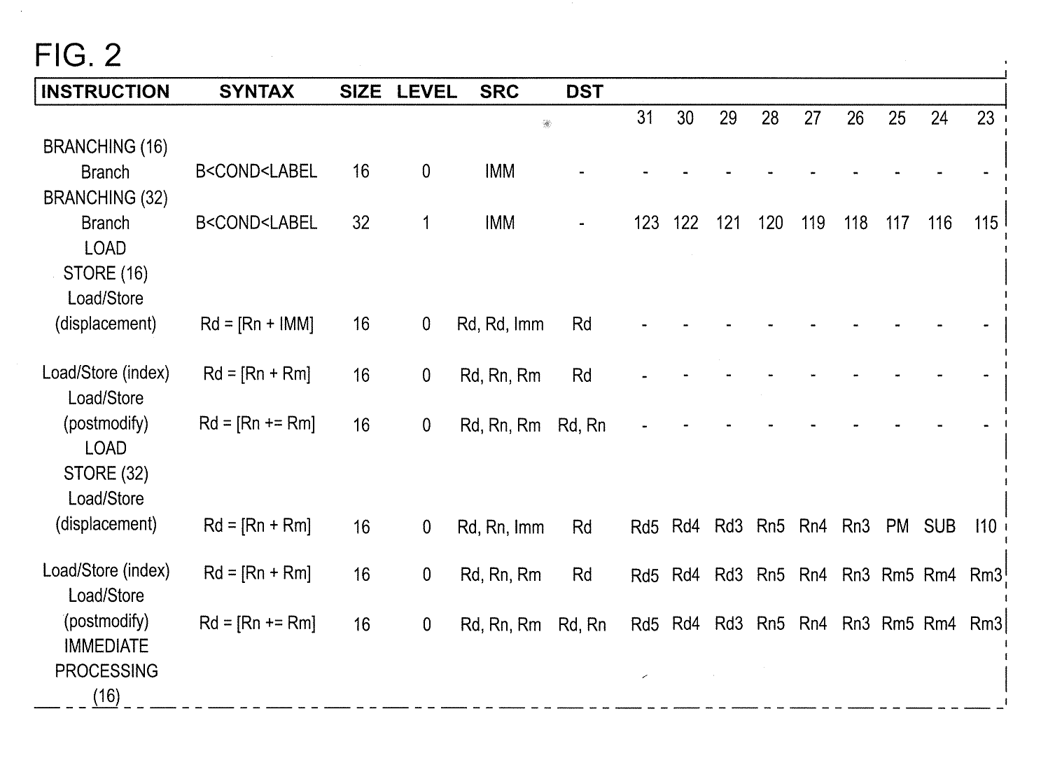

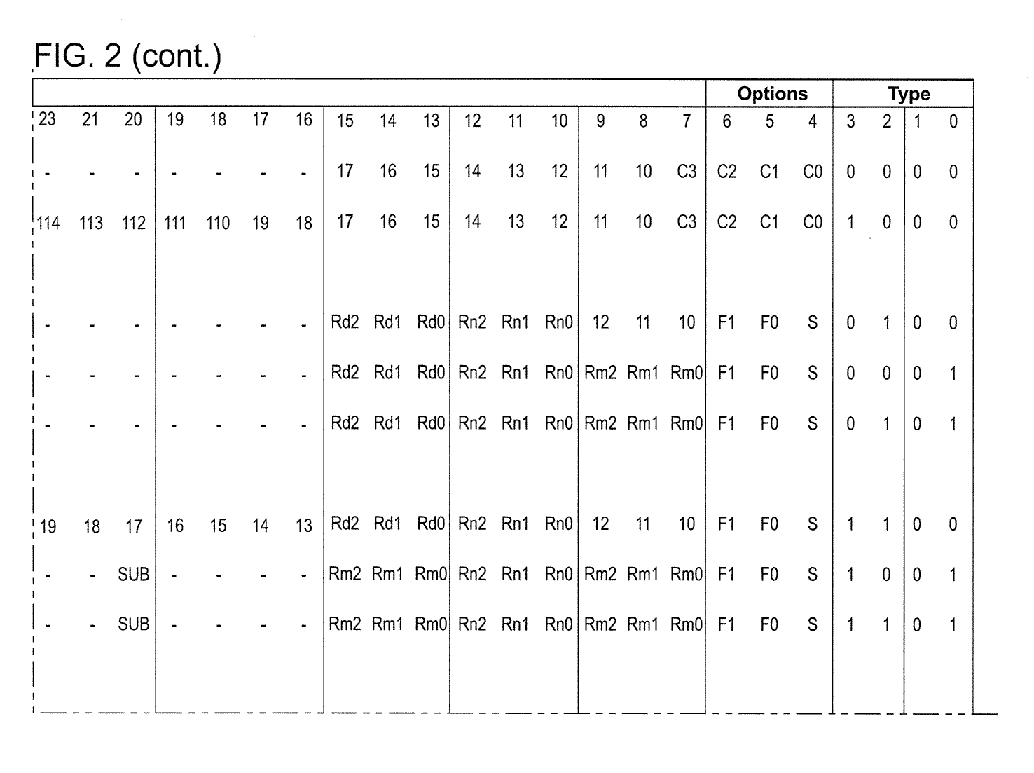

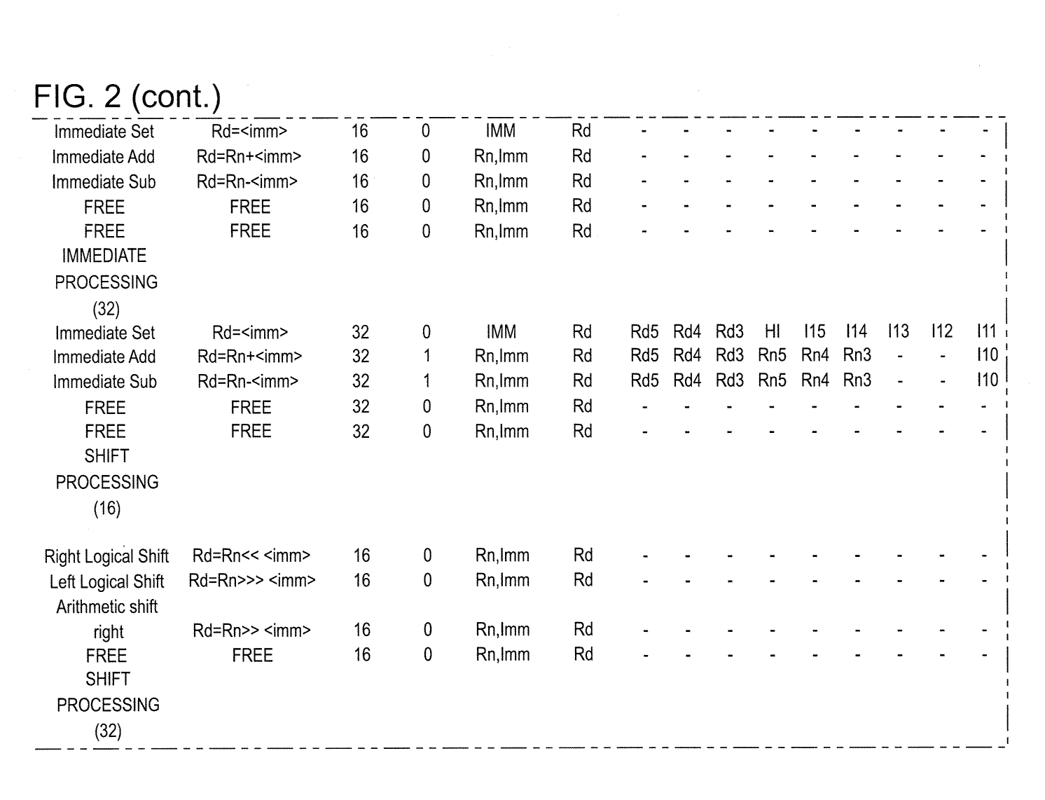

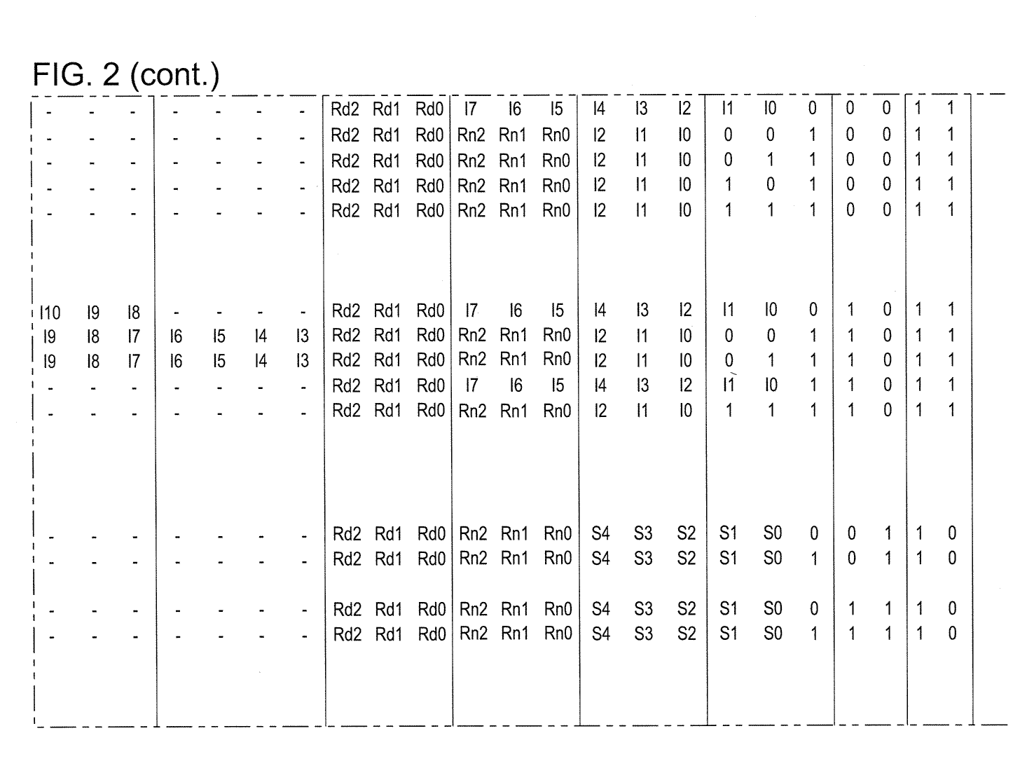

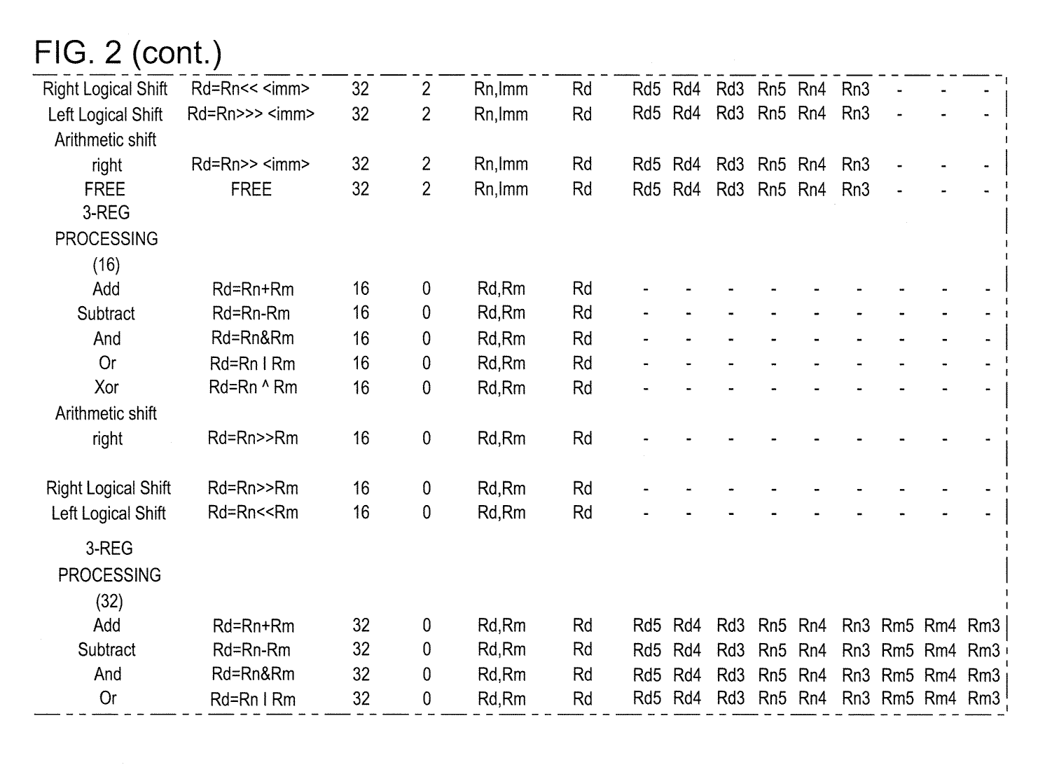

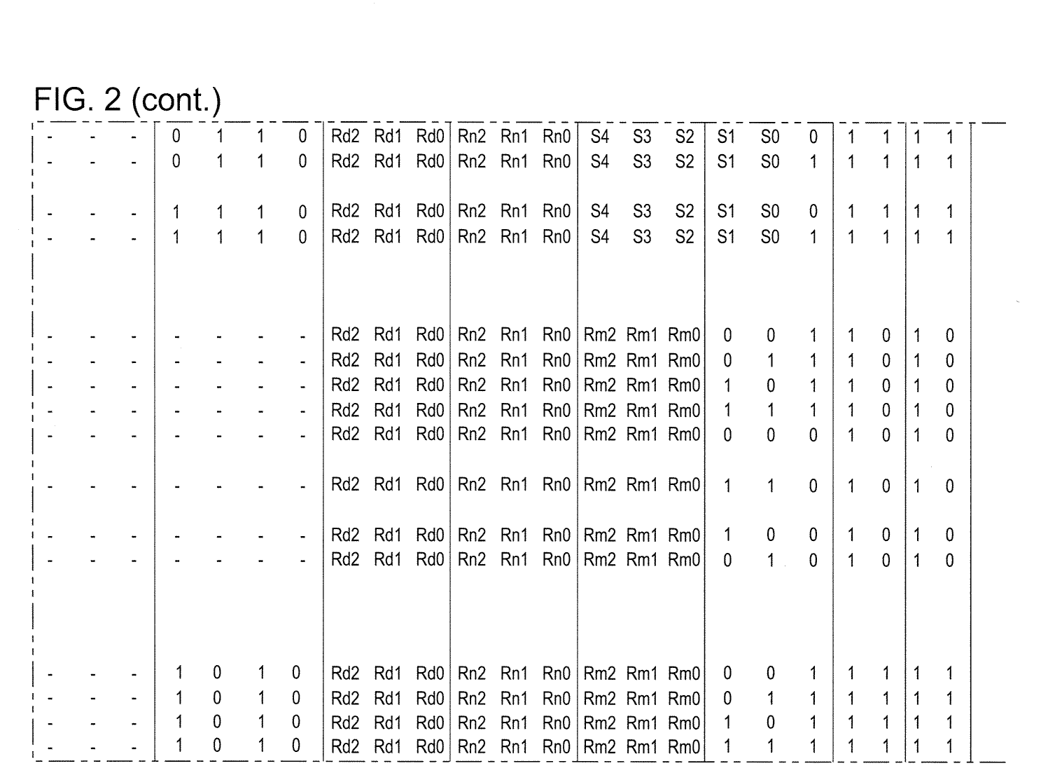

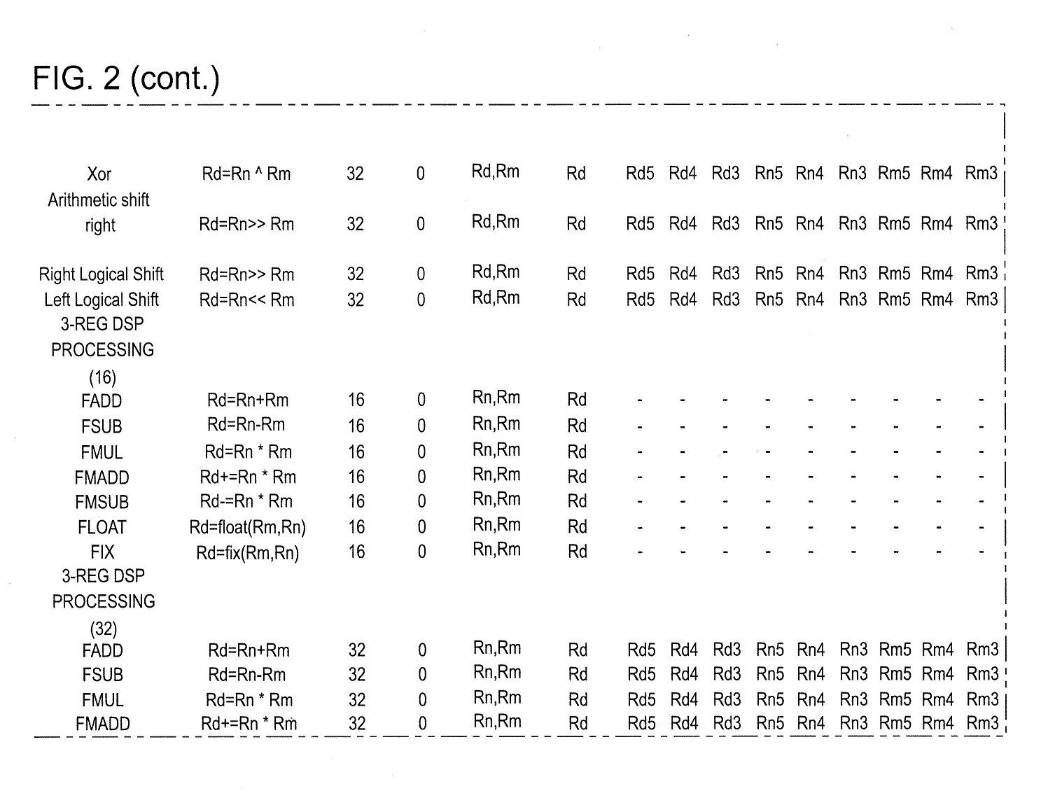

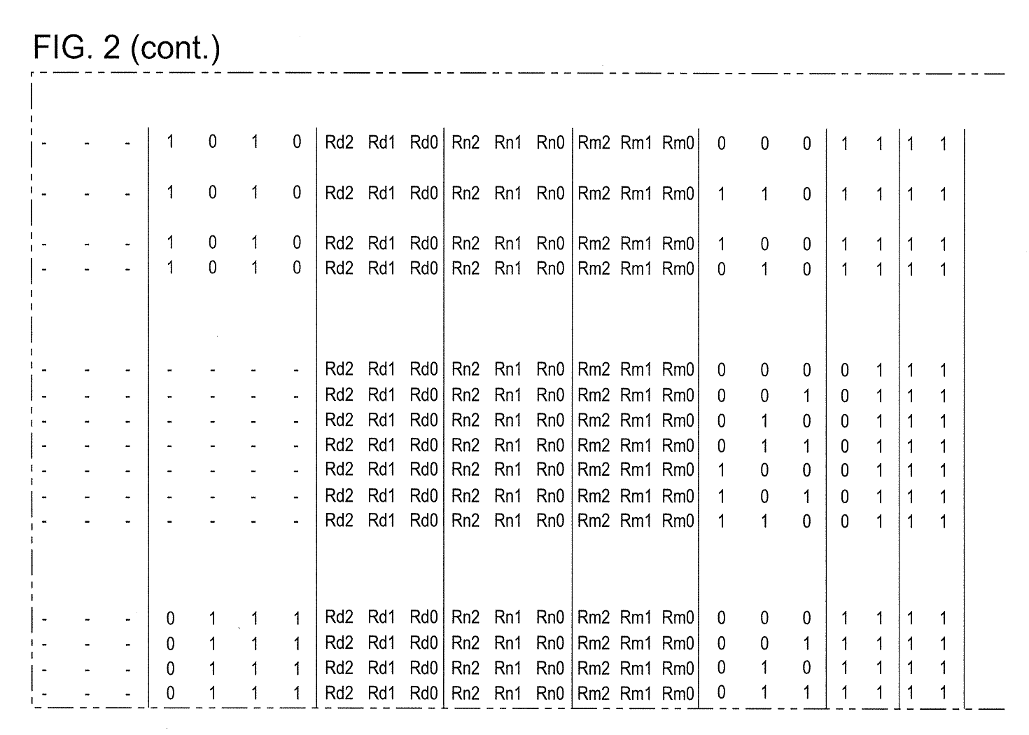

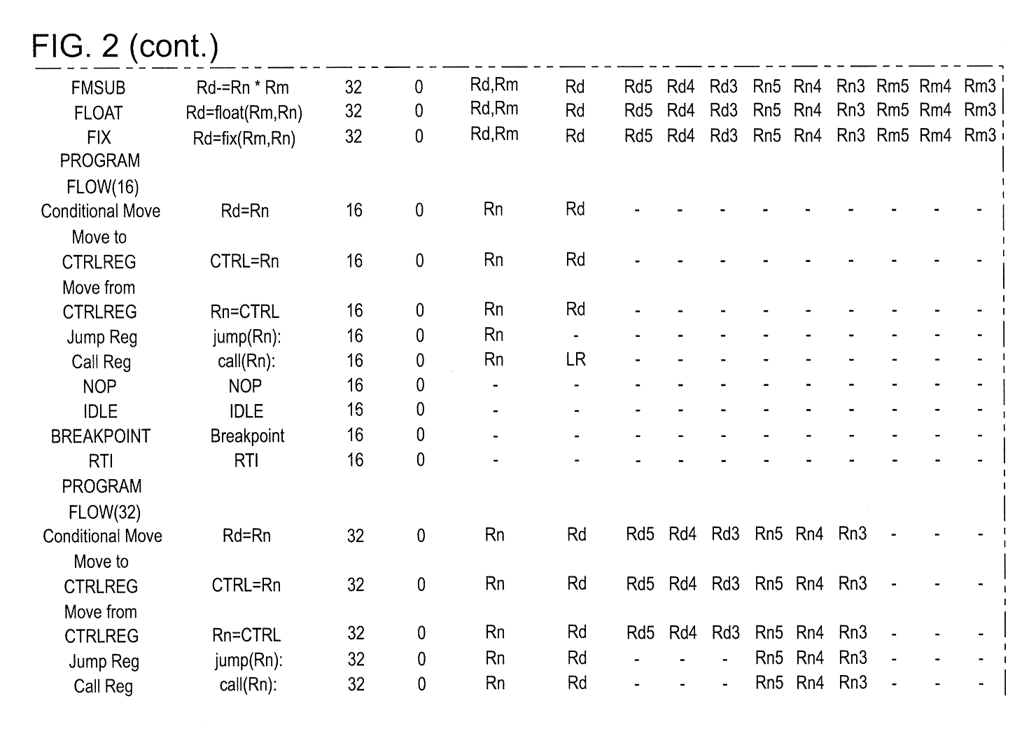

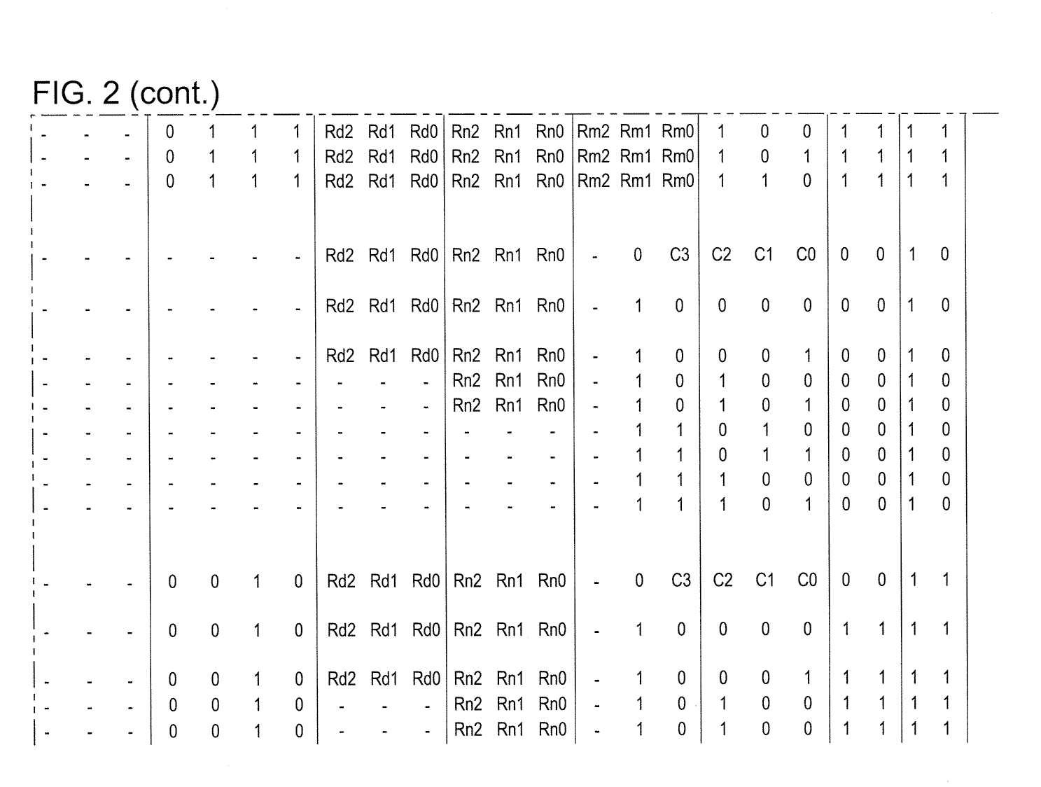

FIG. 2 shows an instruction set. The right-most 4 bits (“Type”) are the least significant bits (LSBs) of the instruction to denote the type of the instruction. The instruction symbols in the table have the following significance:
I=immediate
Rd=destination register
Rn=first source register
Rm=second source register
S0-S4=shift amount
F1-F0=word size for load/store
S=store option
C0-C3=condition code
SES=sign extend
SUB=subtract
PM=POSTMODIFY

Out of the 16 types within the 4-bit type field, one opcode type (1111) is dedicated to extending the instruction to 32 bits. Instructions with immediate values use bit-4 to indicate a long (32-bit) instruction. Encoding the 32-bit instruction as a four bit value can be done with only four gates, which is insignificant when compared to the size of the whole digital signal processor, which can be on the order of 10,000 gates. However, these four gates enable the encoding of a large set of three register arithmetic instructions within a 16-bit instruction field, which can reduce the code size by half in many signal processing functions. If one bit were dedicated to specifying a 16-bit versus 32-bit instruction, only 15 bits would be available for general operation descriptions, which would not have been sufficient to encode all of the key instructions desired. Forcing many key instructions to be encoded as 32-bit instructions would have significantly increased the code size and power consumption of signal processing.

The instructions are 16 bits wide, with the second 16-bit extension adding more registers and longer immediate constants to the 16-bit instruction. The 16-bit instructions have three register fields, each with three bits to identify one of registers R0-R7. The 32-bit instructions have three register fields, each with a total of 6 bits to identify each of 64 registers. The lower three bits of each one of the register fields, Rn, Rm, and Rd, are contained within the first 16 bits, and the upper three bits, i.e., the most significant bits (MSBs), of each one of the register fields are contained within the upper 16 bits of the instruction. Compared to the 16-bit instruction, these three sets of three are the MSBs of the addresses for addressing registers R8 through R63. Any user entered command that uses only registers R0 through R7 are encoded as 16-bit instructions, while commands that use registers R8 through R63 are encoded as 32-bit instructions. When programming in assembly code, the instructions can be specified. A tool can parse the text of the assembly code and determine whether a 16-bit or 32-bit instruction is appropriate based on the registers being used.

The instruction decoding circuitry thus supports the encoding of three-operand instructions within 16-bit instruction widths. Short width instruction sets typically limit instructions to two operand instructions when short instructions are used. Here, all three operands instructions can be encoded as 16-bit instructions. Three-operand instructions can produce more efficient signal processing code than two-operand instructions.

By trading off immediate value fields and the number of different instructions in the architecture, the inclusion of 6 bit register fields is enabled for all source and destination operands in the case of 32-bit instructions. This means that 64 registers can be used in a 32 bit instruction architecture. The use of 64 registers has the potential of significantly improving the efficiency of the code generated by configurable compilers. A larger register file can reduce the number of loads and stores to data memory, and such reduction can improve performance and reduce power consumption.

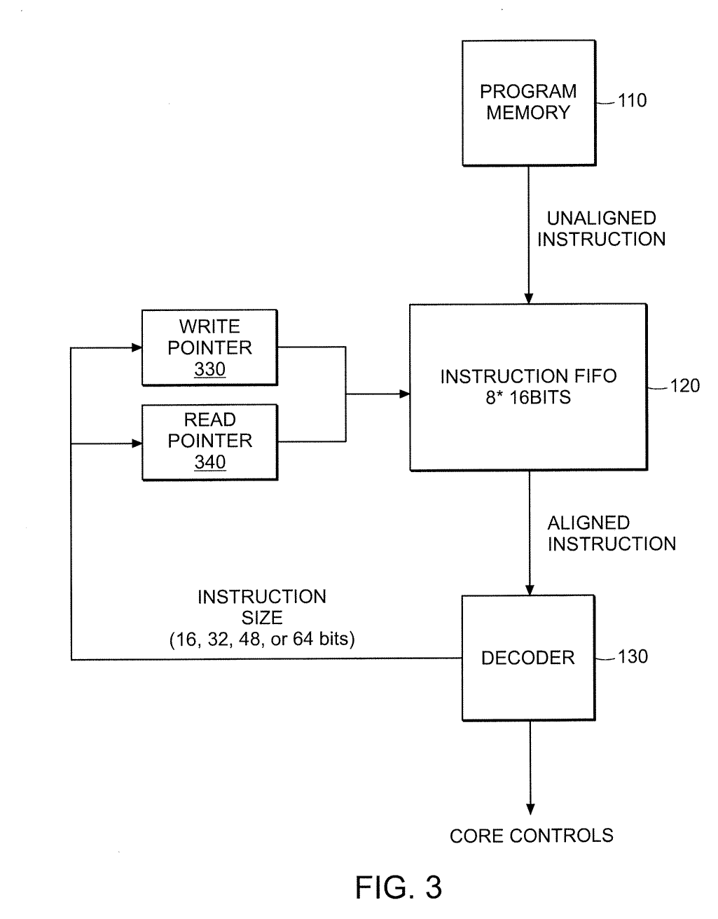

Referring to FIG. 3, to support unaligned instructions, a buffer 120 (FIG. 1) is configured as a local instruction FIFO buffer between program memory 110 and instruction decoder 130. Buffer 120 has eight 16-bit words and holds up two complete memory instruction lines in a temporary storage. The exact buffer location that is written to, and read from, is controlled by a FIFO write pointer 330. FIFO write pointer 330 is a single bit indicating whether the upper four 16-bit words or the lower four 16-bit words should be written to upon an instruction line fetch. The pointer is updated every time an instruction is executed by the core. The buffer pointer update amount depends on the size of the instruction line. Instructions can be 16 or 32 bits and up to two instructions can be executed in parallel, leading to buffer pointer updates of 16, 32, 48, or 64 bits.

Based on the buffer pointer, the instruction buffer 120 selects and sends an instruction to the instruction decoder 130. The program memory needs to be at least 64 bits wide to allow for two 32-bit instructions to be executed in parallel on a continuous basis. The instruction output from the instruction buffer is either 32 bits for the single issue configuration, or 64 bits for the dual issue configuration.

The number of instructions executed depends on the types of instructions currently in the instruction buffer. A legal condition for parallel instruction issue includes: (1) no dependency between the result of the first instruction and the inputs of the second instructions, and (2) no contention on hardware resources, meaning that a load/store instruction can be executed in parallel with a datapath instruction. In this embodiment, the core cannot execute two load/store instructions in parallel or execute two datapath instructions in parallel. All control instructions are executed one at a time.

The size of the instruction is used to update the write pointer and read pointer state machines. A new instruction line is fetched from memory whenever the instruction buffer has 4 empty 16-bit entries. A new instruction line is also fetched from the program memory in case of a program redirection such as a jump instruction or an interrupt request. Although some embodiments include an instruction alignment buffer, there is the possibility of implementing a microprocessor without it. The instruction alignment buffer adds area and power, and there could be applications, predominately 16 bit or 32 bit, that may not benefit from its use.

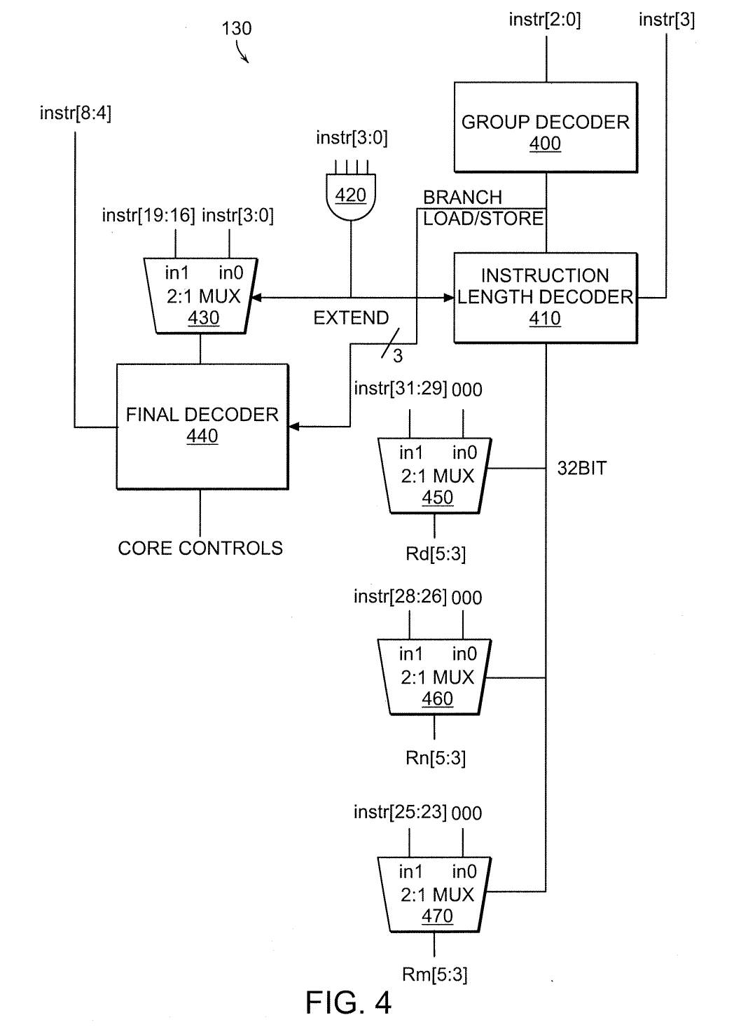

FIG. 4 shows an exemplary circuit structure of the dual width instruction decoder 130 (FIG. 1). The instruction, instr[31:0], is fed into the decoding logic to produce datapath, sequencing, and register file control signals. The decoding circuit includes a group decoder (400) that receives the three LSBs, instr[2:0], and determines if the instruction is a load, store, branch, or other instruction. An “extend” gate (420) looks at the four LSBs, instr[3:0], to determine if the instruction is a 32-bit instruction where the input is (1111), or a 16-bit instruction otherwise. The extend signal determines whether mux 430 will determine whether the ruling opcode for the final decoder (440) should be bits [3:0] or bits [19:16]. A second way for the extend signal to indicate inst[19:16] is for instr[2:0] to indicate a branch or load/store, and for bit 3 of the instruction signal to have a particular logic value. These two ways are used to determine if the instruction is a 32-bit or 16-bit format in an instruction length decoder (410).

Each register, Rn, Rm, and Rd, is designated with six bits indicating which of the 64 registers is being addressed. The 6-bit address for a register is represented generally as Rx[5:0]. For 16-bit instructions that use registers R0-R7, the most significant bits (MSB) are always 000, while the three LSBs indicate that register. For instructions that have 32 bits and use registers R8 through R63, the MSBs are taken from instr[31:29], instr[28:26], and instr[25:23]. The 32-bit signal from instruction length decoder 410 thus indicates to muxes 450, 460, and 470 whether to fill in the register address with leading zeros, or whether to use bits from instr[31:23] as the MSBs of the register address.

The size of the instruction is used to reset the upper field of the operand register addresses and shown in muxes 450, 460, and 470, and to indicate a correct program counter address for the next instruction to be executed.

The decoding logic needed to support the dual length instruction set can be minimal and significantly smaller than other encoding/decoding schemes. The logic added by dual encoding length instructions in this scheme includes (or can be limited to) approximately nine NAND gates for the three operand fields Rn, Rm, and Rd (muxes 450, 460, and 470); approximately eight 2-input NAND gates to create a 32-bit instruction indicator (decoder 410); a four input NAND gate for creating an “extend” signal (gate 420); and four 2:1 muxes to create an extended opcode (mux 430) for the final control decoder (440).

All other instruction decode logic can be completely reused between the 16-bit and 32-bit instruction formats, resulting in a very small, power efficient, and fast dual-length instruction decoding circuit.

One innovation that leads to the efficient instruction decoding method is the use of multiple bits to indicate a 32-bit instruction, forcing each register based instruction to be a 16-bit or 32-bit instruction, depending on the registers used, and having two opcode fields that get selected by a 4-bit “extend” signal derived from a 4-bit opcode. The extended mode detection is then used to select the correct type bits for the general decode logic. By keeping the instruction set minimal, three 8-register operands can be used within a 16-bit instruction and three 64-register operands within a 32-bit instruction.

This architecture can be said to optimize the instruction encode/decode scheme to optimize code density for signal processing applications, while microprocessors and DSPs are typically optimized for control applications.

While DSPs often use two load store units to bring data to and from a register file, in the present architecture, a second load store unit is omitted in favor of more registers. Dual load-store buses can be useful with a smaller register file, but this architecture preferably uses a larger register file.

Individual descriptions of the instructions shown in FIG. 2 are not repeated here, but can be found in Provisional Application Ser. No. 60/197,511 filed Oct. 29, 2008, which is incorporated herein by reference in its entirety.

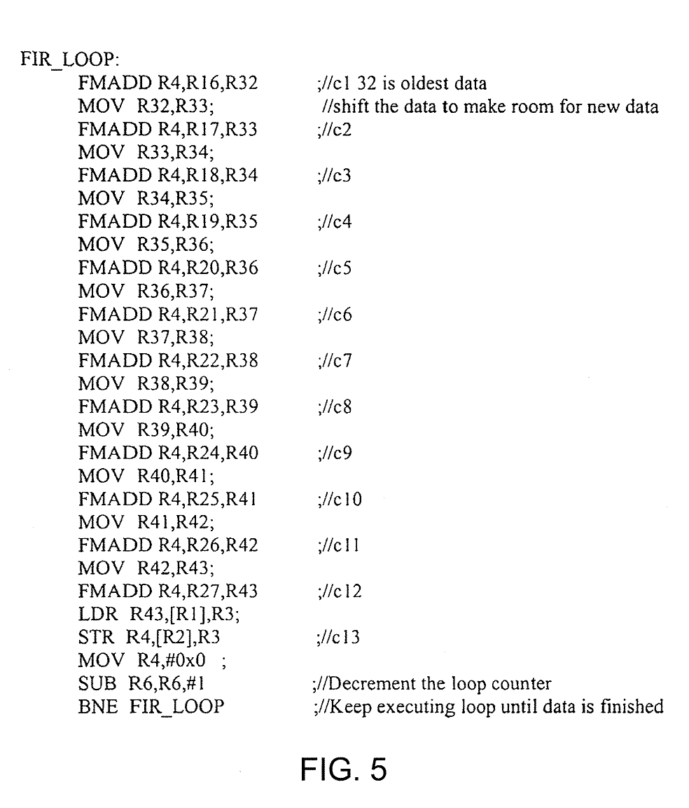

FIG. 5 demonstrates assembly code for the DSP core, executing a 16-point Finite Impulse Response (FIR) filter using a single load-store unit in parallel with an execution unit.

The parallel execution is carried out by the hardware sequencer. As can be seen, the execution unit is being used on every clock cycle, indicating that there is no load-store bottleneck in the application.

Having described certain embodiments, it should be apparent that modifications can be made without departing from the scope, and that other embodiments are within the following claims. For example, while specific numbers of bits have been identified for various aspects including the instruction length, register bits, and extend signal, modifications could be made to different numbers to accommodate a system in a different implementation, while still maintaining basis principles described herein. While the instructions that are used with certain registers have a lower number of bits (e.g., 16 bits for registers R0-R7), additional instructions could be provided that have a greater number of bits (e.g., 32 bits) in call cases regardless of the registers used; in such a case, the LSBs of the instruction received at the decoder would be 1111 to indicate a 32-bit address (using the exemplary embodiment above).

What is claimed:

1. A processor comprising:
a register file including a first set of registers and second set of registers; and
a decoder for receiving instructions and for decoding to provide instructions, wherein the decoder can provide instructions having a first number of bits and instructions having a second number of bits, the second number of bits being greater than the first number of bits, the decoder being responsive to information that indicates whether the first set of registers or the second set of registers is being used to determine whether to provide instruction information with the first number of bits or with the second number of bits.

2. The processor of claim 1, wherein the decode receives an instruction with the second number of bits, reviews a first plurality of bits within the received instruction that can indicate a type of instruction, or can indicate that the type of instruction is encoded in a second plurality of bits, and wherein, in response to the first plurality of bits indicating the type of instruction, the decoder providing an instruction with the first number of bits, and in response to the first instruction indicating that the type of instruction is encoded in a second plurality of bits, the decoder providing an instruction with the second number of bits.

3. The processor of claim 2, wherein the first plurality of bits includes four bits.

4. The processor of claim 2, wherein the first number of bits is 16 and the second number of bits is 32.

5. The processor of claim 2, wherein, for a certain type of instruction encoded in a portion of the first plurality of bits, and responsive to other information in the first plurality of bits, the decoder providing an instruction with the first number of bits or an instruction with the second number of bits.

6. The processor of claim 5, wherein the certain type of instruction is a load/store instruction.

7. The processor of claim 1, wherein the first number of bits is 16 and the second number of bits is 32.

8. The processor of claim 7, wherein the register file is a unified set of 64 registers.

9. The processor of claim 1, wherein the least significant bits (LSBs) of addresses of registers are contained in a first set of bits have the first number of bits, and the most significant bits (MSBs) of addresses of registers are contained in a second set of bits that are not part of the first set of bits.

10. The processor of claim 1, wherein the first number of bits is 16, and wherein at least some of the instructions are three-operand instructions.

11. The processor of claim 10, wherein the second number of bits is 32, and wherein the register file has 64 registers, wherein, for 16-bit instructions, the three significant bits (LSBs) of the registers are contained in a lower set of 16 bits, and wherein the three most significant bits (MSBs) of the registers are contained in an upper set of 16.

12. The processor of claim 1, further comprising a program memory and a buffer, the decoder receiving instructions from the program memory through the buffer, wherein the buffer holds up two complete memory instruction lines in a temporary storage, and wherein the buffer location that is written to, and read from, is controlled by a write pointer that indicates which words should be written to upon an instruction line fetch.

13. The processor of claim 12, wherein the buffer pointer update amount depends on the size of the instruction line, instructions can be 16 or 32 bits, and up to two instructions can be executed in parallel, leading to buffer pointer updates of 16, 32, 48, or 64 bits.

14. The processor of claim 1, further comprising a program memory for holding instructions that are fetched by the decoder, and a tool for parsing code to determine which registers are being used and, in response to the determination of which registers are being used, for providing instructions to the program memory with information indicating whether the instruction should be decoded to have the first number of bits or the second number of bits.

15. A processing system for executing M-bit instructions and N-bit instructions, with N>M, the processor including a register file with Ry registers, wherein the M-bit instructions are executed when the registers being used are R0 through Rx, and wherein N-bit instructions are executed when the registers being used include at least one of R(x+1) through R(y−1).

16. The processor of claim 15, wherein M=16, N=32, x=7, and y=64.

17. In a processor having a program memory, a register file having a first set of registers and a second set of registers, and a decoder, a method comprising:
receiving instructions from program memory and providing output instructions, wherein the output instructions can have either a first number of bits or a second number of bits, the second number of bits being greater than the first number of bits;
in response to information that indicates whether the first set of registers or the second set of registers is being used, determining whether to provide output instructions with the first number of bits or with the second number of bits; and
providing the output instructions.

18. The method of claim 17, the information that indicates whether the first set of registers or the second set of registers is being used includes a first plurality of bits within a received instruction that indicates a type of instruction or can indicate that the type of instruction is encoded in a second plurality of bits, wherein, in response to the first plurality of bits indicating the type of instruction, providing an instruction with the first number of bits, and in response to the first instruction indicating that the type of instruction is encoded in a second plurality of bits, providing an instruction with the second number of bits.

19. The method of claim 17, wherein the first number of bits is 16, and wherein at least some of the instructions are three-operand instructions, and wherein the second number of bits is 32, and wherein the register file has 64 registers, wherein, for 16-bit instructions, the three significant bits (LSBs) of the registers are contained in a lower set of 16 bits, and wherein the three most significant bits (MSBs) of the registers are contained in an upper set of 16.

20. The method of claim 17, further comprising parsing code to determine which registers are being used and, in response to the determination of which registers are being used, providing instructions to the program memory with information indicating whether the instruction should be decoded to have the first number of bits or the second number of bits.
